(19) United States
(12) Patent Application Publication
(10) Pub. No.: US 2005/0072749 A1
(43) Pub. Date: Apr. 7, 2005

(54) Nipple structure for infant use

(76) Inventors: Mark Primavera, Newtown, CT (US); Greg Lalier, Brookfield, CT (US)

Correspondence Address: THEODORE C. JAY, APARTMENT 600, 16 NORTH CHATSWORTH AVE., LARCHMONT, NY, 10538, US

(21) Appl. No.: 10/677,926

(22) Filed: Oct. 2, 2003

(51) Int. Cl. A61J 9/00

(52) U.S. Cl. 215/11.1

(57) ABSTRACT

A first hollow relatively short vertical cylinder is open at its lower end and closed at its upper end, the upper end having a small opening. The cylinder defines a nipple. A horizontally extending thin circular member has a centrally disposed hole aligned with and spaced from the lower end of the nipple. The hole has a periphery. A securing mechanism is disposed between the member and the lower end of the nipple to connect said member via the periphery of the hole to the nipple. A second vertical hollow cylinder is open at both ends and has an exterior diameter which is always much larger than that of the nipple. The upper end of the second cylinder is connected to the mechanism and via the mechanism to the nipple, the interior of the second cylinder communicating with the interior of the nipple.

### FIELD OF THE INVENTION

This invention relates to nipple structures for use by infants in drinking liquids.

### BACKGROUND OF THE INVENTION

In order to feed an infant liquid such as water from a standard wide-mouth bottle, it is known to use a nipple structure and collar, which are detachably connected to the outside threaded surface of the neck. This means of connection cannot be used with the standard water or juice container. Consequently, if an infant and/or child wants to drink from a standard water or juice container using a nipple, the liquid must be transferred to the standard wide-mouth baby bottle. This creates a problem if there is no standard bottle available since the infant and/or child cannot drink from the standard water or juice container without spilling the liquid.

The present invention employs a totally new and different structure that overcomes these difficulties and provides a secure detachable connection for use with standard water or juice containers of various sizes.

### SUMMARY OF THE INVENTION

It is an object of this invention to provide a new and improved nipple structure which is connected detachably to the smooth interior of the neck of the container whereby collapse or accidental discharge cannot occur.

Another object is to incorporate in the new and improved structure a tapered lower cylinder which is inserted detachably into the neck interior and can fit into necks of varying inner diameters.

Yet another object is to incorporate a step-in taper in the tapered lower cylinder which further increases the range of inner neck diameters in which this nipple structure can be used. Still another object is to incorporate in the new and improved structure a member which functions as an anti-choke device to prevent the nipple from falling into the container.

Yet a further object is to provide securing means which prevent malformation of the second cylinder when in use.

These and other objects and advantages of this invention will either be explained or will become apparent hereinafter.

In accordance with the principles of this invention, a nipple structure for infant use utilizes a first hollow relatively short vertical cylinder open at its lower end and closed at its upper end. The upper end of the cylinder has a small opening for passage of liquid. The first cylinder has a uniform diameter and defines a nipple.

A horizontally extending thin circular member has a centrally disposed opening aligned with and spaced from the lower end of the nipple.

Securing means is disposed between the central opening of the member and the lower end of the nipple to connect said member to said nipple.

A second vertical hollow cylinder open at both ends has an interior diameter communicating with the interior of the nipple. The second cylinder has an outer surface with tapers downwardly and inwardly with an exterior diameter which is always much larger than the outer diameter of the nipple. The upper end of the second cylinder is connected to the securing means and communicates with the lower end of the nipple.

In use, the lower end of the cylinder is inserted into the open neck of a container of fluid such as water. The cylinder adjusts to differently sized neck diameters and engages the interior of the neck in such manner that it provides a liquid seal and cannot be dislodged or removed accidentally. The member prevents the nipple from falling into the container.

The securing means, which can take the form of securing ribs, prevents malformation of the lower cylinder which could otherwise cause accidental release of the second cylinder from the neck of the container.

The outer surface of the second cylinder at its upper end is provided with a step-in taper which permits the second cylinder to accommodate even larger diameters,

### BRIEF DESCRIPTION OF THE DRAWINGS

FIG. 1 is a top view of a preferred embodiment of this invention.

FIG. 2 is an orthographic view of the structure of FIG. 1.

FIG. 3 is a side view of the structure of FIG. 1.

FIG. 4 is a detailed view of a modification of the structure of FIG. 1 that enables use with containers of openings larger than standard.

FIG. 5 is a detailed view of the structure of FIG. 1 that enables use with containers of standard sized openings.

FIG. 6 is a vertical cross-sectional view of the structure of FIG. 1 showing its vertical ribs.

### DETAILED DESCRIPTION OF PREFERRED EMBODIMENTS

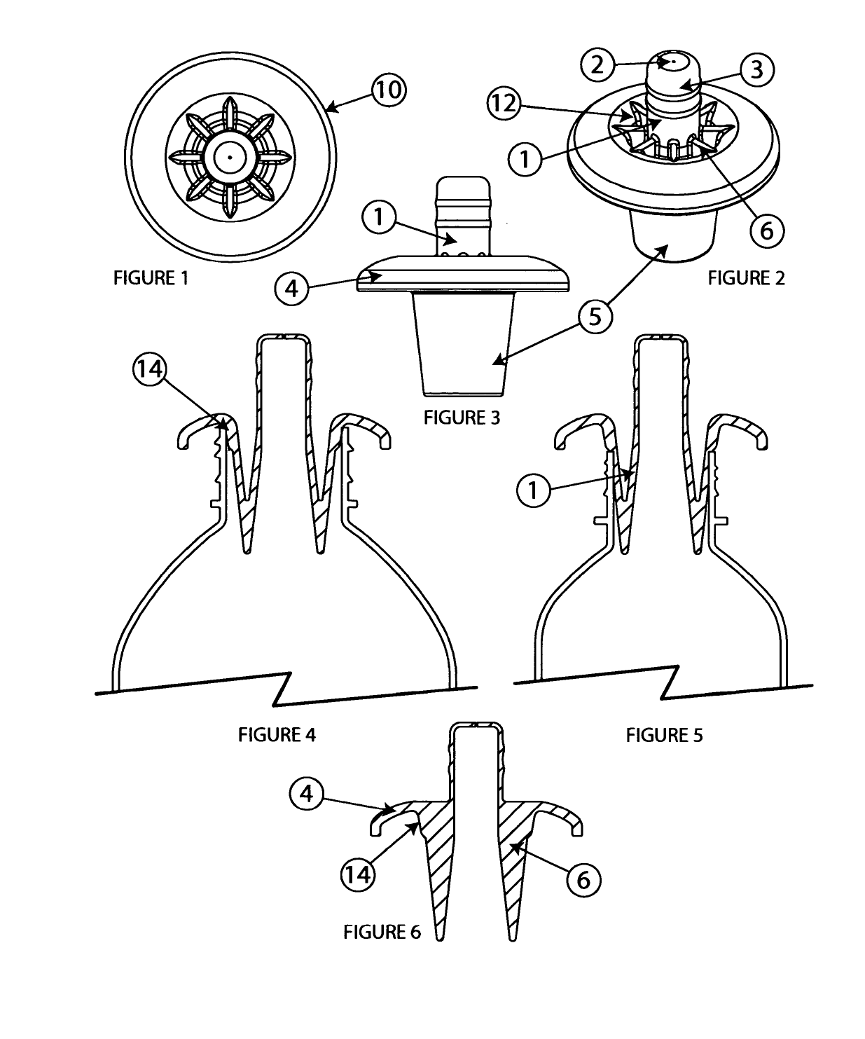

Referring first to FIGS. 1-3 and 6, the nipple structure, typically formed of plastic, is shown in top view at 10. It includes a first hollow relatively short vertical cylinder shown at 1 in FIGS. 3 and 6 is open at its lower end and is closed at its upper end. The top of the upper end has a small opening 2. The cylinder defines a nipple 3 and has a uniform diameter.

A horizontally extending thin circular member 4 has a centrally disposed hole 12 aligned with and spaced from the nipple 3. The hole has a periphery. Securing means are disposed between the periphery of the hole 12 and the lower end of the nipple to connect said member to said nipple.

A second vertical hollow cylinder 5 is open at both ends and has an exterior diameter which is always much larger than the outer diameter of the nipple. The upper end of the second cylinder is connected to the securing means and communicates with the lower end of the nipple. The outer surface of the second cylinder tapers downwardly and inwardly. The inner surface of the second cylinder tapers downwardly and outwardly to avoid excess thickening of this cylinder.

The securing means include uniformly spaced apart vertical ribs 6 which engage the external surface of the first cylinder and extend radially outward from the exterior surface of the first cylinder. The ribs engage the periphery of the hole in the member and extend downwardly to engage the outer surface of the second cylinder. Each rib is thin and has a generally V shaped element which tapers downward to a tip which is flush with the outer surface of the second cylinder.

The shape and size of each rib is determined by the physical properties of the production material selected. The specific number of ribs employed is also determined by these physical properties.

As shown in FIG. 4, when the nipple structure is inserted into the neck of a standard sized water bottle or juice bottle, the lower end of the second cylinder second cylinder engages the interior of the neck in a liquid tight but removable manner and permits and infant and/or child to drink without spillage. The taper of the second cylinder enables the invention to be used when the diameter of the standard sized containers varies somewhat from standard range.

However, as shown in FIG. 4, the cylinder has a short circular outer ridge 14 at its upper end that enlarges the outer surface of the cylinder and enables its engagement with necks of substantially larger diameter.

While the invention has been described with particular reference to the detailed description and the drawings, the protection sought is to be limited only by the terms of the claims that follow.

1. A nipple structure for infant use comprising
a first hollow relatively short vertical cylinder open at its lower end and closed at its upper end, the upper end having a small opening, the cylinder defining a nipple;
a horizontally extending thin circular member having a centrally disposed hole aligned with and spaced from the lower end of the nipple, said hole having a periphery;
securing means disposed between the member and the lower end of the nipple to connect said member via the periphery of the hole to said nipple; and
a second vertical hollow cylinder open at both ends and having an exterior diameter which is always much larger than that of the nipple, the upper end of the second cylinder being connected to said means and via the means to the nipple, the interior of the second cylinder communicating with the interior of the nipple.

2. The nipple structure of claim 1 wherein the first cylinder has a uniform diameter.

3. The nipple structure of claim 2 wherein the outer surface of the second cylinder tapers downwardly and inwardly.

4. The nipple structure of claim 3 wherein the inner surface of the second cylinder tapers downwardly and outwardly.

5. The nipple structure of claim 4 wherein said means includes spaced apart vertical ribs.

6. The nipple structure of claim 5 wherein the ribs are uniformly spaced apart.

7. The nipple structure of claim 6 wherein the ribs extend radially outward from the exterior surface of the first cylinder to engage the periphery of the hole in the member and extend downwardly to engage the outer surface of the second cylinder

8. The nipple structure of claim 7 wherein the ribs extend downwardly and are flush with the second cylinder.

9. The nipple structure of claim 8 wherein each rib is thin and has a generally V shaped element which tapers downward to a tip which is flush with the outer surface of the second cylinder.

10. The nipple structure of claim 3 wherein the outer surface of the second cylinder adjacent its upper end is provided with an enlarged circular ridge.
